(19) United States
(12) Patent Application Publication
(10) Pub. No.: US 2009/0293693 A1
(43) Pub. Date: Dec. 3, 2009

(54) Workpiece splitting and kickback-inhibiting assembly for a table cutting machine

(76) Inventor: Yi-Te Liao, Nantou County (TW)

Correspondence Address: JACOBSON HOLMAN PLLC, 400 SEVENTH STREET N.W., SUITE 600, WASHINGTON, DC, 20004, US

(21) Appl. No.: 12/155,048

(22) Filed: May 29, 2008

(51) Int. Cl. B26D 1/14

(52) U.S. Cl. 83/478

(57) ABSTRACT

A workpiece splitting and kickback-inhibiting assembly includes a splitter adapted to suspend a cover shield over a cutting blade of a table cutting machine, a lug disposed on the splitter and having a retaining hole disposed rearwardly of a seat region, a mounting body detachably straddling on the seat region, two journals extending leftwardly and rightwardly of the mounting body, two kickback-inhibiting plates respectively mounted on the journals to be turnable about the journals and to hold a workpiece fed past the splitter, and a fastening unit having a lever which is pivoted to the mounting body and which has a retaining end that is turnable to engage the retaining hole so as to retain the mounting body on the splitter.

### BACKGROUND OF THE INVENTION

1. Field of the Invention

This invention relates to a workpiece and cutter guard mechanism for a table cutting machine, such as a table saw, more particularly to a workpiece splitting and kickback-inhibiting assembly for mounting a cover shield and for inhibiting kickback of a workpiece fed past the splitter.

2. Description of the Related Art

A conventional table saw is provided with a splitter for entering into a kerf of a workpiece to reduce the possibility of workpiece binding when the workpiece is cut by a saw blade, and two pawl plates which are turnably mounted on two side walls of the splitter to hold down the workpiece when the workpiece is fed past the splitter so as to inhibit kickback. Detachment of the pawl plates from the splitter may be required in a certain cutting process to form a slot in the workpiece, for example.

Referring to FIGS. 1 and 2, a conventional workpiece splitting and kickback-inhibiting assembly 10 includes a splitter 11, a workpiece kickback-inhibiting unit 12, and a quick-release fastening unit 13. The splitter 11 has an upper seat edge 111 and a latch hole 112 below the upper seat edge 111. The workpiece kickback-inhibiting unit 12 includes a mounting body 121, two pawl plates 122 pivoted to two side walls of the mounting body 121, and a torsion spring 123 for biasing the pawl plates 122 downwardly. The mounting body 121 is disposed to ride on the seat edge 111 through a slot 1211. Each of the pawl plates 122 has a lower holding edge 1221 to be in trailing engagement with a workpiece. The fastening unit 13 includes a movable sliding frame 131, a latch 132 disposed on a lower portion of the sliding frame 131 to be inserted into the latch hole 112, a pressing knob 133 disposed on an upper portion of the sliding frame 131, and a spring disposed in the mounting body 121 to bias the sliding frame 131 outwardly. When it is desired to detach the kickback-inhibiting unit 12 from the splitter 11, the pressing knob 133 may be pressed inwardly to move the sliding frame 131 so as to permit disengagement of the latch 132 from the latch hole 112.

However, when it is desired to assemble the kickback-inhibiting unit 12 onto the splitter 11, the latch hole 112 is concealed by the kickback-inhibiting unit 12 so that the user is difficult to observe whether the latch 132 is aligned with the latch hole 112. In other words, the latch 132 must be dimensioned to be fittingly engaged in the latch hole 112 in order for the kickback-inhibiting unit 12 to be mounted firmly on the splitter 11. Hence, alignment of the latch 132 with the latch hole 112 during assembly is inconvenient.

### SUMMARY OF THE INVENTION

An object of the present invention is to provide a workpiece splitting and kickback-inhibiting assembly in which a workpiece kickback-inhibiting unit can be assembled to a splitter in a convenient and secure manner.

According to this invention, the workpiece splitting and kickback-inhibiting assembly includes a splitter, a workpiece kickback-inhibiting unit, and a fastening unit.

The splitter has a major wall which extends substantially in a longitudinal direction and which has two major wall surfaces opposite to each other in a first transverse direction relative to the longitudinal direction. The major wall has an upper end portion which is adapted to suspend a cover shield over a cutting blade of a table cutting machine, and which includes a seat region and a mount region disposed rearwardly of the seat region. A lug extends from the mount region in the longitudinal direction, and has a retaining hole extending therethrough in the first transverse direction.

The workpiece kickback-inhibiting unit includes a mounting body, left and right journals, two kickback-inhibiting plates, and a first biasing member.

The mounting body has left and right side walls which are spaced apart from each other in the first transverse direction and which extend upwardly and in the longitudinal direction to terminate at a straddling portion that detachably straddles on the seat region to permit the left and right side walls to flank the major wall surfaces, respectively. The left and right side walls respectively have left and right bearing surfaces which surround a first axis in the first transverse direction.

The left and right journals respectively have left and right journalled ends respectively supported on the left and right bearing surfaces, and left and right mount ends respectively extending leftwardly and rightwardly of the left and right side walls.

Each of the kickback-inhibiting plates has an upper portion mounted on a respective one of the left and right mount ends, and a hold-down portion extending radially from the upper portion relative to the first axis and terminating at a pawl end that is turnable about the first axis to be disposed in trailing engagement with a workpiece fed past the splitter.

The first biasing member is disposed to urge the pawl ends to turn about the first axis so as to ensure the trailing engagement of the pawl ends with the workpiece.

The fastening unit includes a lever and a second biasing member.

The lever has a middle fulcrum pivotally mounted on the mounting body about a second axis in a second transverse direction transverse to both the longitudinal direction and the first transverse directions, a retaining end which is disposed to confront the lug in the first transverse direction and which is turnable about the second axis between an engaging position, where the retaining end is engaged in the retaining hole so as to retain the mounting body on the splitter, and a disengaging position, where the retaining end is disengaged from the retaining hole so as to permit detachment of the mounting body from the splitter, and an operating end opposite to the retaining end to be operable manually.

The second biasing member is disposed to bias the retaining end to the engaging position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a conventional workpiece splitting and kickback-inhibiting assembly for a table cutting machine;

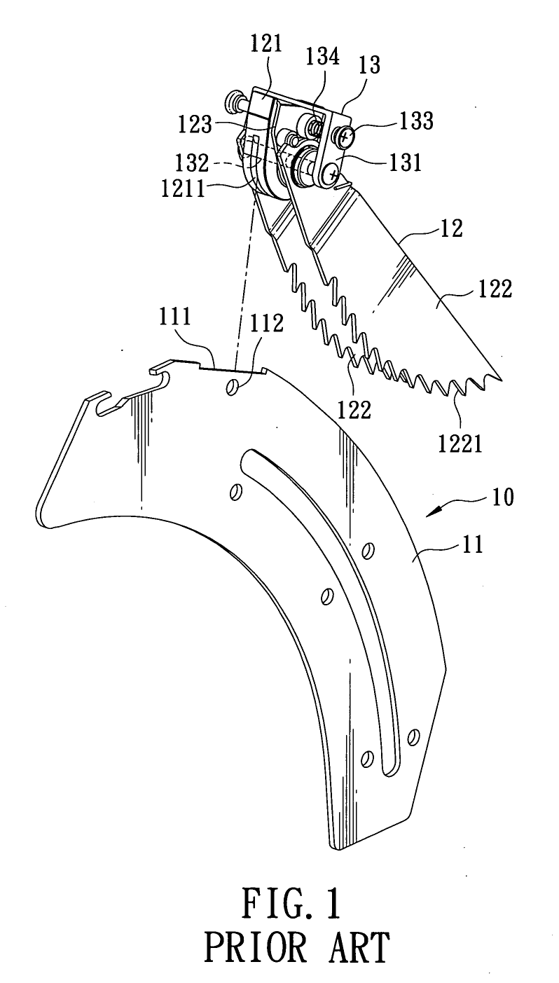

FIG. 2 is a schematic side view of the conventional workpiece splitting and kickback-inhibiting assembly;

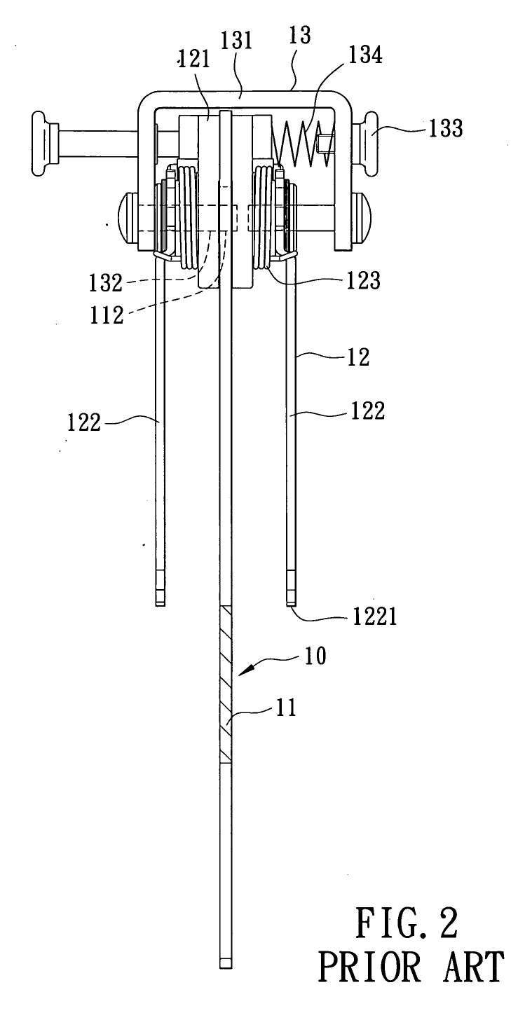

FIG. 3 is an exploded perspective view of the preferred embodiment of a workpiece splitting and kickback-inhibiting assembly according to this invention;

FIG. 4 is a perspective view of the preferred embodiment when assembled;

FIG. 5 is a schematic side view of the preferred embodiment;

FIG. 6 is a schematic top view of the preferred embodiment;

FIG. 7 is a fragmentary sectional view taken along lines VII-VII of FIG. 6;

FIG. 8 is a schematic view viewed from lines VIII-VIII of FIG. 5, and showing a fastening unit of the preferred embodiment;

FIG. 9 is a sectional view taken along lines IX-IX of FIG. 5, showing a retaining end of a lever of the fastening unit retained in a retaining hole;

FIG. 10 is a schematic view similar to FIG. 8, but showing the retaining end disengaged from the retaining hole; and

FIG. 11 is a fragmentary schematic view of the preferred embodiment, showing a workpiece kickback-inhibiting unit detached from a splitter.

### DETAILED DESCRIPTION OF THE PREFERRED EMBODIMENT

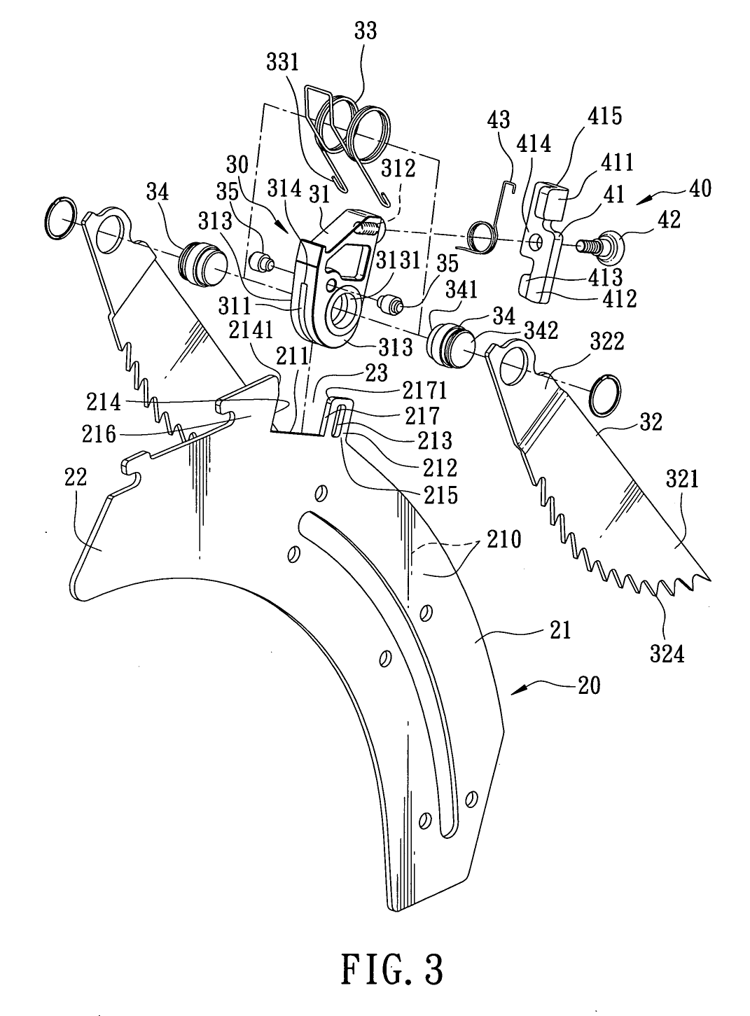

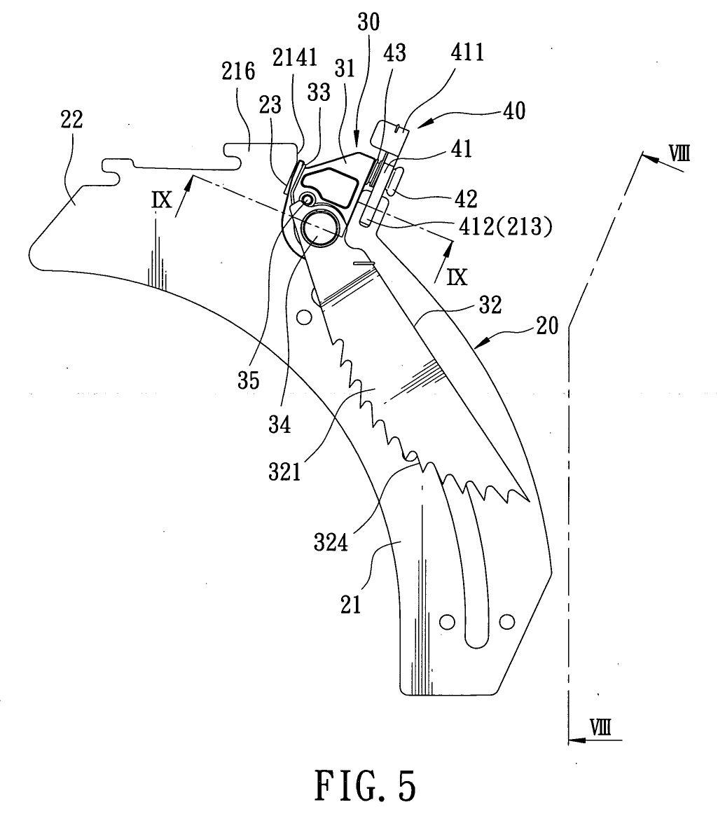

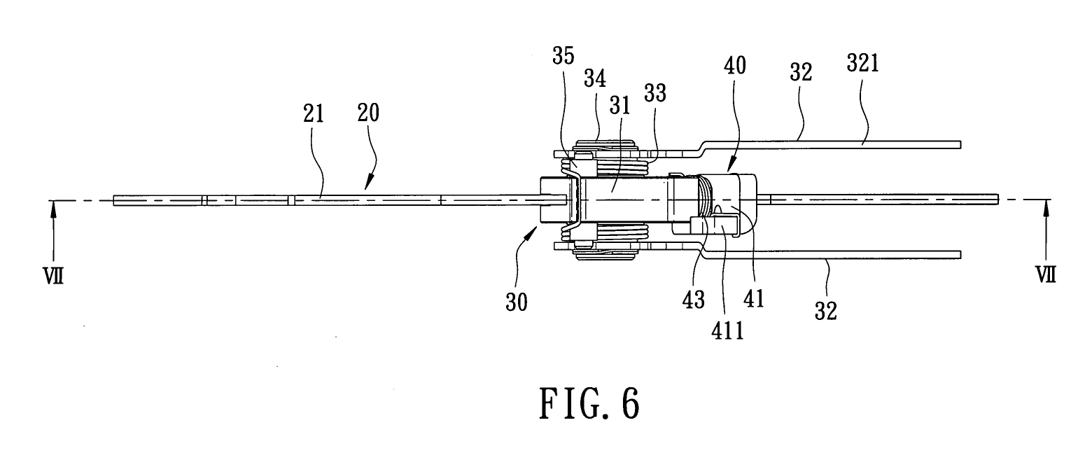

Referring to FIGS. 3 to 6, the preferred embodiment of a workpiece splitting and kickback-inhibiting assembly according to the present invention is shown to comprise a splitter 20, a workpiece kickback-inhibiting unit 30, and a fastening unit 40.

The splitter 20 has a major wall 21 which extends substantially in a longitudinal direction and which has two major wall surfaces 210 opposite to each other in a first transverse direction relative to the longitudinal direction. The major wall 21 has an upper end portion 22 which is adapted to suspend a cover shield (not shown) over a cutting blade of the table cutting machine, and which includes a seat region 211 and a mount region 215 disposed rearwardly of the seat region 211. A lug 212 is integrally formed with and extends from the mount region 215 in the longitudinal direction, and has a retaining hole 213 extending therethrough in the first transverse direction. A barrier wall 216 is integrally formed with and extends from the upper end portion 22 of the splitter 21 in the longitudinal direction, and cooperates with the seat region 211 and the lug 212 to define an accommodation space 23 of rectangular shape. The barrier wall 216 and the lug 212 respectively have front and rear abutment surfaces 214,217 confronting each other in a second transverse direction transverse to both the longitudinal direction and the first transverse direction.

The workpiece kickback-inhibiting unit 30 includes a mounting body 31, left and right journals 34, two kickback-inhibiting plates 32, a first biasing member 33, and two stoppers 35.

The mounting body 31 is dimensioned to be fittingly inserted into the accommodation space 23. Preferably, the front abutment surface 214 of the barrier wall 216 and the rear abutment surface 217 of the lug 212 respectively have front and rear entry regions 2141,2171 that are spaced from each other by the largest distance so as to facilitate insertion of the mounting body 31 into the accommodation space 23. The mounting body 31 has left and right side walls 313 which are spaced apart from each other in the first transverse direction by a slot 311 and which extend upwardly and in the longitudinal direction to terminate at a straddling portion 314 that detachably straddles on the seat region 211 to permit the left and right side walls 313 to flank the major wall surfaces 210, respectively. The left and right side walls 313 respectively have left and right bearing surfaces 3131 which surround a first axis in the first transverse direction. The mounting body 31 has a screw hole 312 which is formed above the left and right side walls 313 and which extends along a second axis in the second transverse direction.

The left and right journals 34 respectively have left and right journalled ends 341 respectively supported on the left and right bearing surfaces 3131. The left and right journals 34 respectively have left and right mount ends 342 which are respectively opposite to the left and right journalled ends 341 and which respectively extend leftwardly and rightwardly of the left and right side walls 313.

Each of the kickback-inhibiting plates 32 has an upper portion 322 mounted on a respective one of the left and right mount ends 342, and a hold-down portion 321 extending radially from the upper portion 322 relative to the first axis and terminating at a pawl end 324 that is turnable about the first axis to be in trailing engagement with a workpiece fed past the splitter 21.

The first biasing member 33 is a torsion spring which has two ends 331 to respectively urge the pawl ends 324 of the plates 32 to turn about the first axis so as to ensure the trailing engagement of the pawl ends 324 with the workpiece.

The stoppers 35 are disposed on the mounting body 31, and respectively extend leftwardly and rightwardly from the left and right side walls 313, respectively, to restrain the extent of turning of the kickback-inhibiting plates 32, respectively.

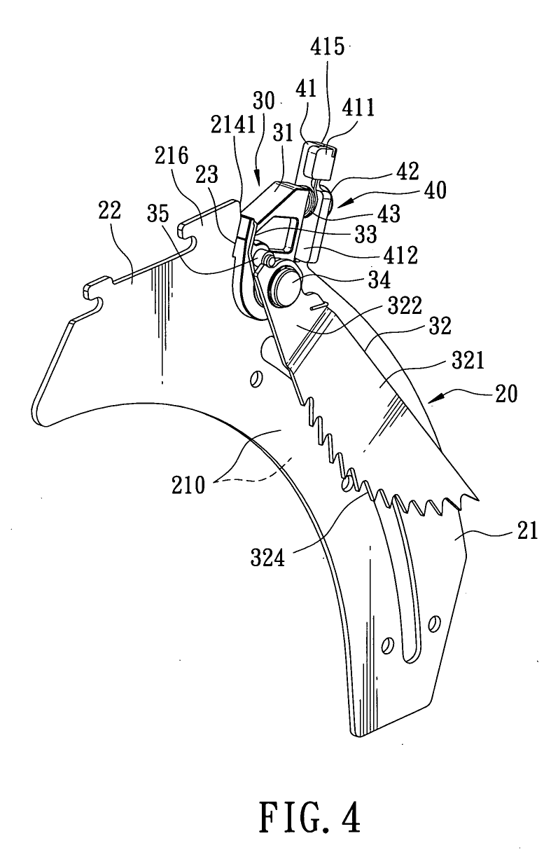

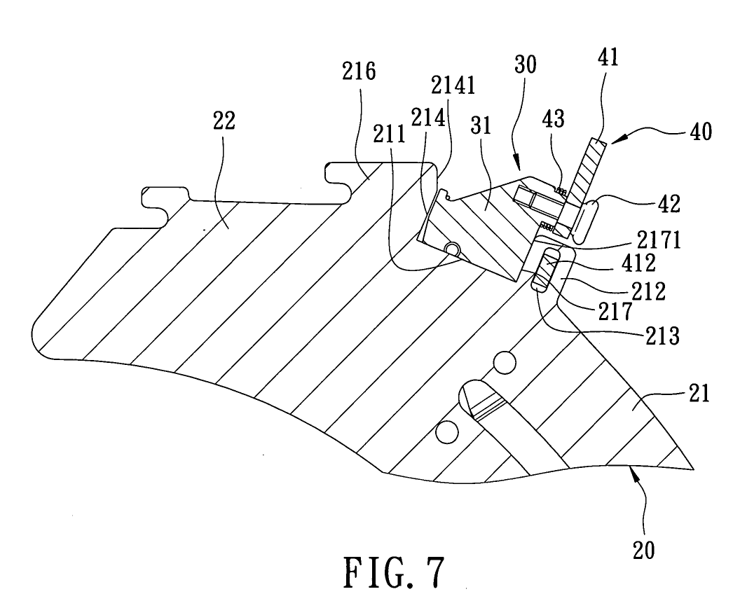

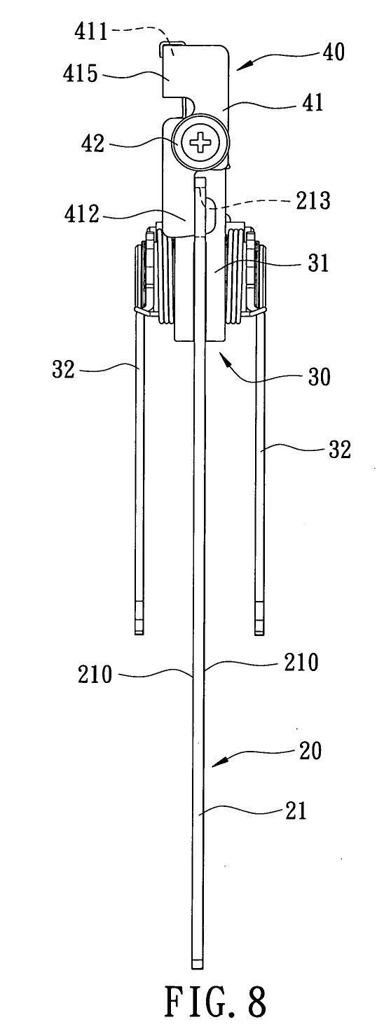

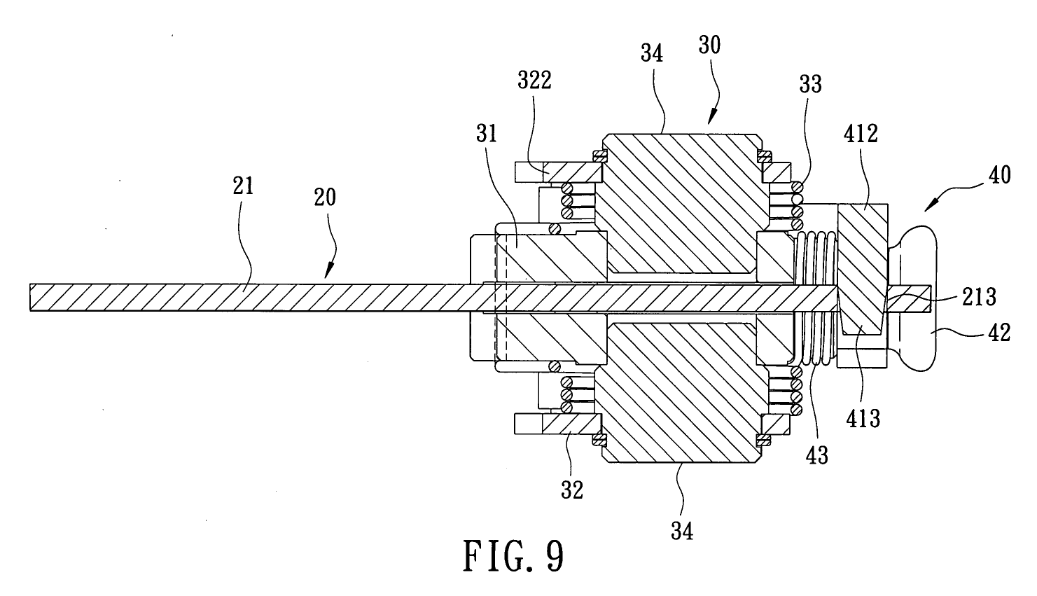

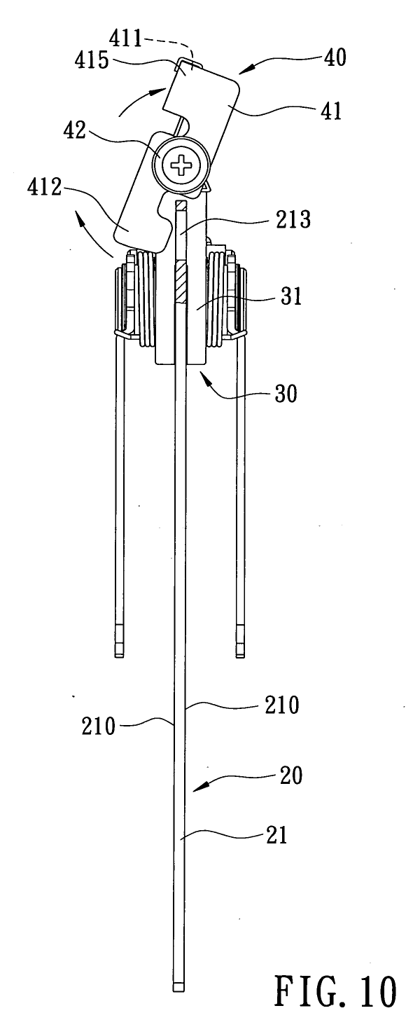

The fastening unit 40 includes a lever 41 and a second biasing member 43. The lever 41 is of an S-shape, and has a middle fulcrum 414 which is pivotally mounted on the mounting body 31 about the second axis by means of a screw bolt 42 that is threadedly engaged with the screw hole 312, and a retaining end 412 which is disposed to confront the lug 212 in the first transverse direction and which is turnable about the second axis between an engaging position, as shown in FIGS. 4 to 9, where the retaining end 412 is engaged in the retaining hole 213 so as to retain the mounting body 31 on the splitter 20, and a disengaging position, as shown in FIG. 10, where the retaining end 412 is disengaged from the retaining hole 213 so as to permit detachment of the mounting body 31 from the splitter 20. The lever 41 further has an operating end 415 disposed opposite to the retaining end 412 to be operable manually, and a handgrip 411 which extends from the operating end 415 in the second transverse direction to facilitate pressing of the handgrip 411 to shift the retaining end 412 to the disengaging position. Preferably, the retaining end 412 of the lever 41 is configured to be fittingly engaged in the retaining hole 213 in the engaging position, and has a tapered tip 413 to facilitate insertion into the retaining hole 213.

The second biasing member 43 is a coil spring which has an end abutting against the lever 41 to bias the retaining end 412 to the engaging position.

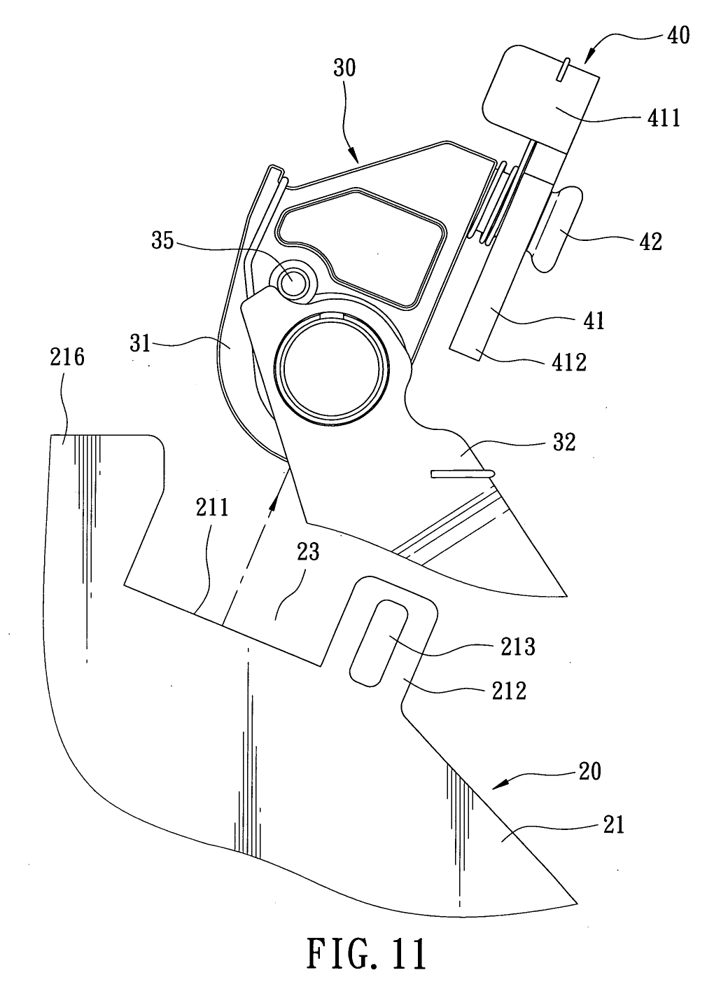

When it is desired to detach the workpiece kickback-inhibiting unit 30 from the splitter 20, the user can press the handgrip 411 to permit turning of the lever 41 so that the retaining end 412 is disengaged from the retaining hole 213. Subsequently, the mounting body 31 is lifted to be removed from the accommodation space 23, as shown in FIG. 11.

As illustrated, according to this embodiment, since the lever 41 is turnably shifted between the engaging and disengaging positions, and since the retaining hole 213 is formed rearwardly of the accommodation space 23 to permit easy viewing of the retaining hole 213, alignment of the retaining end 412 with the retaining hole 213 as the workpiece kickback-inhibiting unit 30 is assembled to the splitter 20 is convenient to perform. Moreover, the front and rear entry regions 2141,2171 facilitate the insertion of the mounting body 31 into the accommodation space 23. The has tapered tip 413 facilitates the insertion of the retaining end 412 into the retaining hole 213, and firm engagement of the mounting body 31 with the splitter 20 can be ensured.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A workpiece splitting and kickback-inhibiting assembly for a table cutting machine, comprising:
a splitter having a major wall which extends substantially in a longitudinal direction and which has two major wall surfaces opposite to each other in a first transverse direction relative to the longitudinal direction, said major wall having an upper end portion which is adapted to suspend a cover shield over a cutting blade of the table cutting machine, and which includes a seat region and a mount region disposed rearwardly of said seat region;
a lug extending from said mount region in the longitudinal direction, and having a retaining hole which extends therethrough in the first transverse direction;
a workpiece kickback-inhibiting unit including
a mounting body having left and right side walls which are spaced apart from each other in the first transverse direction and which extend upwardly and in the longitudinal direction to terminate at a straddling portion that detachably straddles on said seat region to permit said left and right side walls to flank said major wall surfaces, respectively, said left and right side walls respectively having left and right bearing surfaces which surround a first axis in the first transverse direction,
left and right journals which respectively have left and right journalled ends that are respectively supported on said left and right bearing surfaces, and which respectively have left and right mount ends that are respectively opposite to said left and right journalled ends, and that respectively extend leftwardly and rightwardly of said left and right side walls,
two kickback-inhibiting plates, each of which has an upper portion mounted on a respective one of said left and right mount ends, and a hold-down portion extending radially from said upper portion relative to the first axis and terminating at a pawl end that is turnable about the first axis to be disposed in trailing engagement with a workpiece fed past said splitter, and
a first biasing member disposed to urge said pawl ends to turn about the first axis so as to ensure the trailing engagement of said pawl ends with the workpiece; and
a fastening unit including
a lever which has a middle fulcrum that is pivotally mounted on said mounting body about a second axis in a second transverse direction transverse to both the longitudinal direction and the first transverse directions, a retaining end that is disposed to confront said lug in the first transverse direction and that is turnable about the second axis between an engaging position, where said retaining end is engaged in said retaining hole so as to retain said mounting body on said splitter, and a disengaging position, where said retaining end is disengaged from said retaining hole so as to permit detachment of said mounting body from said splitter, and an operating end that is disposed opposite to said retaining end to be operable manually, and
a second biasing member disposed to bias said retaining end to the engaging position.

2. The workpiece splitting and kickback-inhibiting assembly according to claim 1, further comprising a barrier wall which extends from said upper end portion of said splitter in the longitudinal direction and which cooperates with said seat region and said lug to define an accommodation space that is dimensioned to permit fitting insertion of said mount body thereinto.

3. The workpiece splitting and kickback-inhibiting assembly according to claim 2, wherein said barrier wall and said lug respectively have front and rear abutment surfaces which confront each other in the second transverse direction, and which respectively have front and rear entry regions that are spaced from each other by the largest distance so as to facilitate the insertion of said mounting body into said accommodation space.

4. The workpiece splitting and kickback-inhibiting assembly according to claim 2, wherein said lug and said barrier wall are integrally formed with said splitter.

5. The workpiece splitting and kickback-inhibiting assembly according to claim 1, wherein said lever has a handgrip which extends from said operating end of said lever in the second transverse direction to facilitate pressing of said handgrip to shift said retaining end to the disengaging position.

6. The workpiece splitting and kickback-inhibiting assembly according to claim 1, wherein said retaining end of said lever is configured to be fittingly engaged in said retaining hole in the engaging position, and has a tapered tip to facilitate insertion of said retaining end into said retaining hole.

7. The workpiece splitting and kickback-inhibiting assembly according to claim 1, wherein said workpiece kickback-inhibiting unit includes two stoppers which are disposed on said mounting body and which respectively extend leftwardly and rightwardly from said left and right side walls to restrain extent of turning of said kickback-inhibiting plates, respectively.
